(19) United States
(12) Patent Application Publication
(10) Pub. No.: US 2016/0120310 A1
(43) Pub. Date: May 5, 2016

(54) DEVICE FOR BRAKING A MOVEMENT

(71) Applicant: GRASS GMBH, HOCHST (AT)

(72) Inventor: Boris KRUEDENER, Darmstadt (DE)

(21) Appl. No.: 14/993,491

(22) Filed: Jan. 12, 2016

Related U.S. Application Data
(63) Continuation of application No. PCT/EP2014/063510, filed on Jun. 26, 2014.

(30) Foreign Application Priority Data
Jul. 18, 2013 (DE) 20 2013 006 474.9

(51) Int. Cl. A47B 96/00; F16F 13/08

(52) U.S. Cl. CPC A47B 96/00; F16F 13/08

(57) ABSTRACT

Proposed is a device for braking, as a result of damping, a movement of a furniture part which is movable relative to a carcass, the device including at least two damper parts. In this case, a first damper part is movable relative to a second damper part and a damping element is mounted with a deforming element on one of the two damper parts. A substantial feature of the device consists in that an abnormally viscous fluid is held in the deforming element.

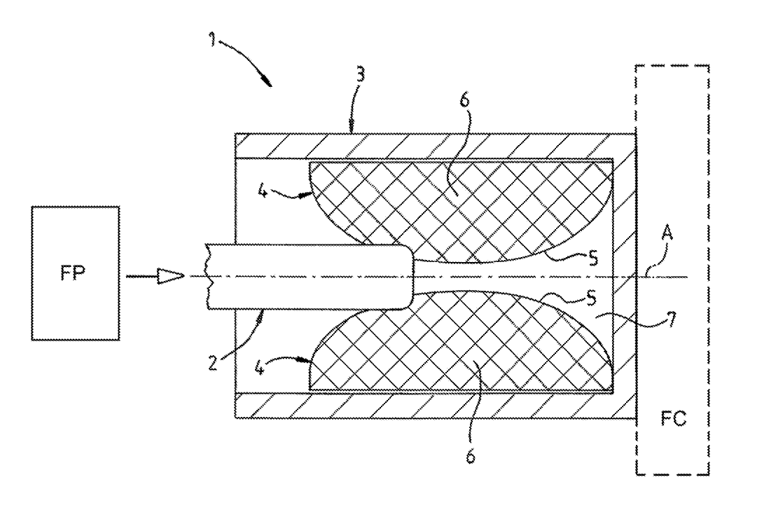

### CROSS REFERENCE TO RELATED APPLICATIONS

This application is a continuation of International Application No. PCT/EP2014/063510 filed Jun. 26, 2014, which designated the United States, and claims the benefit under 35 USC §119(a)-(d) of German Application No. 20 2013 006 474.9 filed Jul. 18, 2013, the entireties of which are incorporated herein by reference.

### FIELD OF THE INVENTION

The invention relates to a device for braking a movement, a guiding device and a furniture item.

### BACKGROUND OF THE INVENTION

Furniture items frequently comprise furniture parts which are mounted so as to be movable, for example, with reference to a furniture carcass or, for example, to one another. The most varied realizations of devices for braking a movement of a movable furniture part such as, for example, a drawer, are known in the area of furniture construction above all in order to avoid damage and loud noises. As a result of the braking action of such devices, speeds of a movable furniture part can be reduced and, where applicable, even restricted. Hard impacts, for example, when knocking against a mechanical stop, which can result in wear marks and sometimes in damage which impairs operation, can consequently be avoided.

However, known devices for braking a movement of a furniture part are frequently only designed for a predetermined range of speeds and of actuating forces in order to avoid premature damage caused by wear within the Predetermined range when utilizing a furniture item. Damage caused by speeds and forces outside the predetermined range, in contrast, are accepted as difficult to avoid. In addition, known braking devices can comprise, for example, sensor means by way of which a braking performance of the device is able to be matched to a speed that occurs or to a corresponding pulse.

### SUMMARY OF THE INVENTION

The object underlying the present invention is to provide a device for braking a movement of a furniture part which is movable relative to a carcass, the device comprising an improved damping action with a comparatively compact design.

The present invention proceeds from a device for braking, as a result of damping, a movement of a furniture part which is movable relative to a carcass, the device including at least two damper parts. In this case, a first damper part is movable relative to a second damper part. In addition, a damping element is mounted with a deforming element on one of the two damper parts.

The core of the present invention consists in that an abnormally viscous fluid is held in the deforming element. With a normally viscous fluid, a braking force which increases in a linear manner, i.e. proportionally, with respect to a speed of a body that is moved therein can be generated on a body which is in contact with the fluid. In contrast, a braking force, which is connected in a non-linear manner, for example exponentially or for example logarithmically, to the speed of a body that is moved therein—at least within a predetermined speed range—can be generated with an abnormally viscous fluid.

The abnormally viscous fluid can be a liquid such as, for example, an oil, the abnormal viscosity of which is produced by a proportion of large molecules, for example macromolecular hydrocarbon compounds. In addition, the abnormally viscous fluid can be a liquid with an admixture. The admixture can be, for example, a powder or granulate of a solid substance.

By using an abnormally viscous fluid, the device according to the present invention provides the advantage that braking effects which differ comparatively greatly from one another are able to be provided for different speed ranges. In this case, the braking effect within different speed ranges can be varied in such a manner that a predetermined first speed range is hardly achievable or is not achievable at all. By way of the abnormal viscosity of the fluid, the device is preferably tuned in such a manner that a furniture part experiences a disproportionate rise in braking force when a predetermined second speed range is exceeded. In this case, impacts can be advantageously reduced or completely prevented, as a result of which damage to, for example, stored goods of a movable furniture item, in particular for example of a furniture door, for example of a flap or for example of a drawer, is avoidable.

The abnormally viscous fluid, in this case, is arranged in such a manner between the first and the second damper parts that forces are transferable between the two damper parts—at least in part—by means of the abnormally viscous fluid. The abnormally viscous fluid is provided for the purpose of at least part of a braking force for damping being achievable as a result of the abnormally viscous fluid being deformed and/or being set into motion. For a comparatively simple realization of the present invention, the deforming element, for example, can be an open, in particular, rigid receptacle in which the abnormally viscous fluid is collected. A plunging element, for example, in the form of a pin, which is realized on one of the damper parts, can reach in a movable manner into the deforming element in such a manner that, for example, the pin is plunged into the abnormally viscous fluid and on account of the displacement is exposed to a resistance of the fluid when moving through the fluid. For example, a section over which the device is able to provide a braking effect can be predetermined by a length of the deforming element.

The consistency of the fluid is preferably such that relatively small braking forces oppose the plunging element—for example a pin—in the case of movements within the predetermined second speed range. The second speed range is preferably limited to speeds which are adapted to a comparatively comfortable and speedy operation of the furniture part. The first speed range can be preset above the second speed range. Unwanted high speeds can be braked more strongly in the first speed range than, for example, speeds of the second speed range which have been accepted as normal in the design, for example, of a movable bearing arrangement of a furniture part. Because the different damping performance or braking performance is based on the characteristic material properties of the abnormally viscous fluid, which is used as a damping medium, it is possible to dispense with a mechanical or electronic control device for adapting a braking force. Consequently, a comparatively simple and in particular compactly designed damping device is able to be provided.

A preferred embodiment of the present invention consists in that the deforming element includes a receptacle in which the abnormally viscous fluid is enclosed in a tight manner. This provides the advantage of the fluid not being able to escape from the device. In addition, it can consequently be ensured in an advantageous manner that the composition of the abnormally viscous fluid cannot be changed, for example, as a result of vaporization or chemical reaction.

The receptacle is preferably elastically deformable. For example, the receptacle can include two pot-shaped sleeves which can be plugged into one another and one spring, for example, the spring, in a relaxed state, connecting the two sleeves in a plugged-together state and telescopic position. The pot-shaped sleeves can be filled with the fluid in order to oppose a rapid telescoping of the sleeves with a greater resistance than a comparatively slow one. Restoring forces which, in particular, once the two damper parts have interacted, return the fluid into a predetermined arrangement, can be held ready as a result of the elastic deformability of the receptacle.

In addition, it is preferred that the abnormally viscous fluid is shear-thickeningly viscous. In the case of shear-thickening viscosity, the braking force of the fluid increases disproportionately to the speed of a body that is moved therein. The shear-thickeningly viscous fluid is advantageously suitable, in particular, for avoiding speeds of the first speed range.

According to a further realization of the present invention, an opening, which is realized for guiding through one of the two damper parts, can be realized on the deforming element. The deforming element is preferably realized in such a manner that in a relative position of the first and of the second damper part with respect to one another a sealing effect is able to be generated at least at times. In this case, a braking effect can be created in two ways: on the one hand, one of the damper parts is able to be braked as a result of friction on the deforming element. On the other hand, one of the damper parts can displace, for example, a gas or another liquid which can be situated at times in the other of the damper parts. In this case, the liquid or the gas can escape between the deforming element and one of the damping parts. A drop in pressure between the damper parts can be dependent, in this case, on a flexibility of the deforming element and, in Particular, of the abnormally viscous fluid held therein, as a result of which a space between one of the damper Parts and the deforming element is influenced. When the plunger is introduced comparatively quickly into the hollow body, a comparatively rapid increase in pressure is generated which can result in a stiffening of the deforming element and in particular of the abnormally viscous fluid held therein. As a result of the stiffening of the deforming element and of the abnormally viscous fluid, the sealing deforming element is not able to expand for a quicker reduction in pressure, as a result of which the increasing pressure is counteracted substantially just by the movement of the plunger. This provides, for example, the opportunity to prevent the plunger from knocking against an end wall.

In a similar sense, the damping element can include a valve device, for example, the deforming element forming a valve body of the valve element.

In this connection, the elastic deforming element can be realized as a closing body of the valve device, past which a second fluid, which is displaceable by way of one of the damper parts out of the other of the damper parts, can be guided on the deforming element. The deforming element, in this case, can be formed relatively simply, for example as an elastic ball. In particular as a result of the abnormally viscous fluid held in the deforming element, depending on the rise in pressure in the second fluid, the closing body can be adapted in a variously quick manner to a form of a valve seat of the valve device. As a result, in a relatively compact method of construction qualitatively different damping performances can be provided in an advantageous manner for braking a movable furniture item.

A further realization of the present invention consists in that the damper part, which is arranged so as to be displaceable in relation to the damping element, comprises several portions with a different cross section, in particular, with different cross sectional surfaces. In particular, it is preferred that the cross section of two longitudinal portions of the damping part alters in a transition portion which is shorter than each of the longitudinal portions along a longitudinal axis of the damping part. In this way, the non-linear displacement performance of the abnormally viscous fluid can be utilized several times over different portions in order to achieve a severe reduction in speed. The deforming element is preferably realized as a surface friction body for this purpose.

For a comparably simple and reliable design, the first damper part can be realized as a hollow body, in particular as a hollow cylinder. In this case, the first damper part can be closed, for example, on one side. In this case the second damper part is preferably realized as a plunger which is adapted for insertion into the first damper part.

The device is additionally realizable in such a manner that the deforming element is realized as an impact body for the damper part which is movable in relation thereto, wherein an impact portion can be adapted to the deforming element on the damper part. With a device for braking a movement, in particular, according to one or several of the aforementioned realizations, a guiding device, with which a movable furniture part is guidable on a furniture carcass of a furniture item, is able to be designed in an advantageously compact manner.

In addition, a device for braking according to the invention is advantageously usable in a furniture item, as a result of which comparatively more space can be made available for the furniture item.

### BRIEF DESCRIPTION OF THE DRAWING

An exemplary embodiment of the present invention is described below by way of the single FIGURE which shows a side view in a vertical section of the present invention, further advantages of the present invention being provided.

### DETAILED DESCRIPTION OF THE INVENTION

The FIGURE shows a side view in vertical section of a device 1 according to the invention along a central longitudinal axis A. The device comprises a first damper element in the form of a plunger 2 which is insertable into a second damper part 3 which comprises the form of a hollow cylinder that is closed on one side.

A damping element 4 in the form of a ring-shaped or hose-shaped cushion is mounted inside the damper part 3. The damping element 4 comprises a deforming element 5 in the form of an elastic cover which can consist, for example, of rubber or silicone rubber. The deforming element 5 seals a cavity in a tight manner which, with an abnormally viscous fluid, can consist, for example, of a mixture of a clay powder and water. In this case, the deforming element can be filled with the fluid in such a manner that the deforming element closes an inner region 7 of the damper part 3 or leaves open only a passage with a comparatively small cross section.

The first damper element, the plunger 2, is arranged in such a manner that its longitudinal axis is moved along the central axis in a parallel manner such that the free-standing end of the plunger is able to be pushed between the portions of the elastic cover of the deforming element 5 which are arranged next to one another on the central axis or directly abut against one another there. When the plunger 2 is pushed between the cover regions on the axis A, the abnormally viscous fluid 6 is displaced and as a result set in motion. In the case of a slow movement of the damper part 2, the displacement movement of the fluid 6 also remains slow such that only a little or hardly any ascertainable, in particular, noticeable stiffening takes place.

However, where the damper part 2 penetrates rapidly into the damper part 3, a rapid deforming of the damping element 4 can take place in such a manner that at least part of the fluid held in the deforming element 5 is accelerated comparatively quickly to high speeds such that the viscosity of the fluid 6 increases in a strongly disproportionate manner. The higher viscosity is connected to lesser mobility of the fluid 6 and is synonymous with increased stiffening of the damping element 4. On account of the increased rigidity, the damping element 4 opposes the penetrating movement of the plunger 2 with disproportionate increased resistance and brakes said plunger all the stronger.

### LIST OF REFERENCES

1 Device
2 Damper part
3 Damper part
4 Damping element
5 Deforming element
6 Fluid
7 Space
FP Furniture part
FC Furniture carcass

1. A device for braking, as a result of damping, a movement of a furniture part which is movable relative to a furniture carcass, said device including at least two damper parts, wherein one first damper part is movable relative to a second damper part, wherein a damping element with a deforming element is mounted on one of the two damper parts, and wherein an abnormally viscous fluid is held in the deforming element.

2. The device as claimed in claim 1, wherein the deforming element includes a receptacle in which the abnormally viscous fluid is enclosed in a tight manner.

3. The device as claimed in claim 2, wherein the receptacle is elastically deformable.

4. The device as claimed in claim 1, wherein the abnormally viscous fluid is shear-thickeningly viscous.

5. The device as claimed in claim 1, wherein the deforming element further comprises an opening for guiding therethrough one of the two damper parts.

6. The device as claimed in claim 1, wherein the deforming element provides a sealing effect at least at times in a relative position of the first and of the second damper parts with respect to one another.

7. The device as claimed in claim 1, wherein the damping element includes a valve device.

8. The device as claimed in claim 7, wherein the deforming element is a closing body of the valve device, Past which a second fluid, which is displaceable by way of one of the damper parts out of the other of the damper parts, can be guided on the deforming element.

9. The device as claimed in claim 1, wherein one of the damper parts, which is arranged so as to be displaceable in relation to the damping element, comprises several portions with a different cross section, in particular with different cross sectional surfaces.

10. The device as claimed in claim 9, wherein the cross section of two longitudinal portions of the one of the damping parts alters in a transition portion which is shorter than each of the longitudinal portions along a longitudinal axis of the damping part.

11. The device as claimed in claim 1, wherein the deforming element is a surface friction body.

12. The device as claimed in claim 1, wherein the deforming element is an impact body for one of the damper parts which is arranged so as to be detachable from the deforming element, wherein an impact portion is adapted to the deforming element on the damper part.

13. The device as claimed in claim 1, wherein the first damper part is a hollow body, in particular as a hollow cylinder.

14. The device as claimed in claim 1, wherein the second damper part is a plunger which is adapted for insertion into the first damper part.

15. A guiding device by way of which a movable furniture item is guidable on a carcass of a furniture item, having a device as claimed in claim 1.

16. A furniture item having a device as claimed in claim 1.
